(19) United States
(12) Patent Application Publication
(10) Pub. No.: US 2006/0074801 A1
(43) Pub. Date: Apr. 6, 2006

(54) Method of effecting a payment to a service provider on behalf of a member of a medical scheme and a system therefor

(76) Inventor: Alan Pollard, Sandton (ZA)

Correspondence Address: MARSHALL & MELHORN, FOUR SEAGATE, EIGHT FLOOR, TOLEDO, OH, 43604, US

(21) Appl. No.: 11/198,206

(22) Filed: Aug. 5, 2005

(30) Foreign Application Priority Data
Aug. 6, 2004 (ZA) 2004/6294

(51) Int. Cl. G06Q 40/00

(52) U.S. Cl. 705/40

(57) ABSTRACT

A method of effecting a payment to a service provider on behalf of a member of a medical scheme includes receiving a request from a service provider for payment in respect of services provided to a member of the medical insurance scheme. If payments made to service providers on behalf of the member exceed a predetermined amount within a predetermined period then requesting a payment from a credit facility of the member and if a payment from the credit facility of the member is approved then effecting payment to the service provider.

### BACKGROUND OF THE INVENTION

This invention relates to a method of effecting a payment to a service provider on behalf of a member of a medical scheme and a system therefor.

A traditional medical scheme operates where the provider of the medical scheme undertakes liability in return for a premium or contribution and provides to members who pay such premiums or make such contributions, relevant health services and or assistance in defraying expenses incurred in connection with rendering such relevant health services.

Typically, the amount of expenses the scheme will incur on behalf of the member is preset and if the amount is exceeded, the member will be required to fund the expense. In such cases, there is often an inconvenience to the member to arrange payment and an inconvenience to the service provider who will typically have to wait longer to obtain payment.

The invention provides a method of effecting a payment to a service provider on behalf of a member of a medical scheme and a system therefor.

### SUMMARY OF THE INVENTION

According to an example embodiment there is provided a method of effecting a payment to a service provider on behalf of a member of a medical scheme:
receiving a request from a service provider for payment in respect of services provided to a member of the medical insurance scheme;
determining if payments made to service providers on behalf of the member exceed a predetermined amount within a predetermined period;
if payments made exceed the predetermined amount, requesting a payment from a credit facility of the member; and
if a payment from the credit facility of the member is approved then effecting payment to the service provider.

In another embodiment an electronic system for effecting a payment to a service provider on behalf of a member of a medical scheme includes:
a memory for storing:
   information relating to payments made to service providers on behalf of a member in a predetermined period; and
   information relating to a predetermined amount payable; and
a processor disposed in communication with the memory, the processor being adapted to:
   receive a request from a service provider for payment in respect of services provided to a member of the medical insurance scheme;
   determining if payments made to service providers on behalf of the member exceed the predetermined amount within a predetermined period;
   if payments made exceed the predetermined amount, requesting a payment from a credit facility of the member, and
   if a payment from the credit facility of the member is approved then effecting payment to the service provider.

### BRIEF DESCRIPTION OF THE DRAWINGS

FIG. 1 is a flow chart illustrating the methodology of the present invention; and

FIG. 2 is a flow chart illustrating how different systems communicate with one another to implement the present invention.

### DESCRIPTION OF A PREFERRED EMBODIMENT

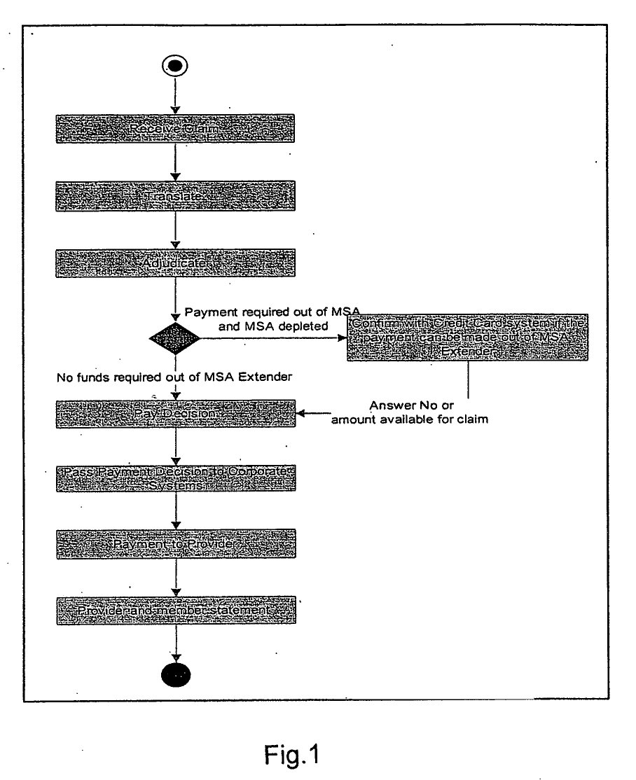

Referring to FIG. 1, a provider of a medical scheme receives a request from a service provider for payment in respect of services provided to a member of the medical insurance scheme.

The received request is in the form of a claim from the provider. The claim is translated and adjudicated by the systems of the medical scheme meaning that the data from the claim is extracted, the nature of the claim identified and a decision is taken as to whether the claim is valid and the service provider should be paid.

Once the payment is authorised, a decision needs to be taken if payments previously made to service providers on behalf of the member exceed a predetermined amount within a predetermined period.

This is because the medical scheme typically insures the member up to a certain predetermined amount and if the amount is exceeded, the member will be required to fund the service providers themselves. For example, a member may have a limit of R1,000 for medication for a calendar year. Once the medical scheme has paid R1,000 for medication on the members behalf the medical scheme will not pay for any further medication during the calendar year.

In such circumstances, a service provider submitting a claim for payment for medication issued to the member will have the claim refused by the medical scheme and will need to revert to the member for payment.

This is inconvenient for both the service provider who will have a delay in receiving payment and for the member who now needs to arrange separately for payment.

According to the present invention, if payments made to service providers on behalf of the member exceed a predetermined amount within a predetermined period a request for payment is automatically generated and transmitted to a credit facility for the payment.

The credit facility is typically in the form of a credit card facility of the member that the member has with a financial institution.

If payment from the credit facility of the member is approved then payment to the service provider will be effected.

The member will obviously be billed in the normal manner by the financial institution.

Although the member is required to authorise the use of the credit facility, the member will not be required to authorise the use of the credit facility for a particular transaction.

Obviously, in order to implement the above-mentioned scheme systems need to be implemented between the medical scheme and the external financial institution.

In some jurisdictions legislation prevents medical schemes from extending credit to its members. As such, the present invention may need to be implemented in conjunction with a financial institution such as a bank.

It will be appreciated that in this scenario the systems of the medical scheme need to communicate with the systems of the financial institution.

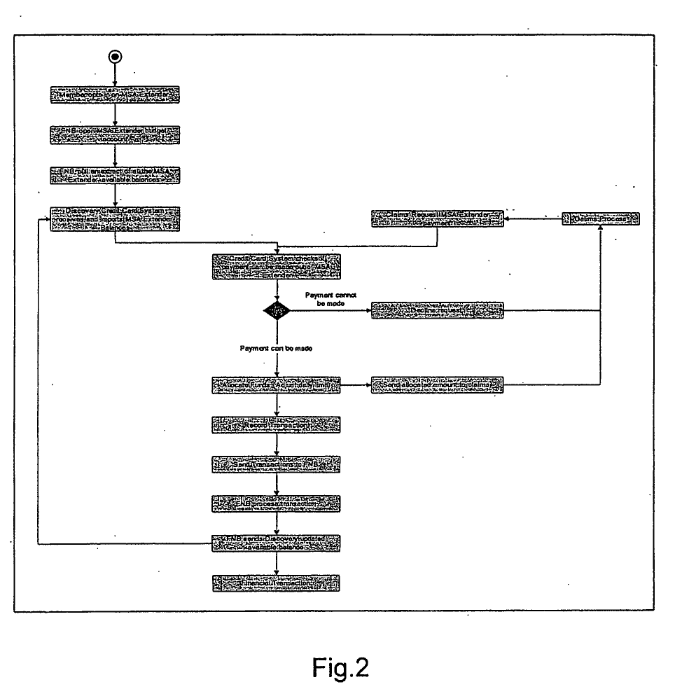

FIG. 2 illustrates an exemplary methodology of the communicating systems.

Once a member agrees to the credit facility, a credit account referred to as an Medical Budget Facility (MBF) is opened by the financial institution. The system of the financial institution extracts all available balances and transfers these to the credit card system of the medical scheme.

If a payment is required to be made from the credit facility, the medical scheme system checks to see if funds are available. If funds are not available, the request is declined and the claim rejected.

If the funds are available, funds are allocated for the particular claim in the medical scheme system and information is communicated to the financial institution to allow the claim to be processed.

The information to process the claim will obviously need to include an identification of the member, an identification of the third party to whom the amount is to be paid and the amount to be paid.

The financial institution continually updates the available balances by transmitting this information to the system of the medical scheme.

An electronic system to implement the invention includes a memory for storing information relating to payments made to service providers on behalf of a member in a predetermined period and information relating to a predetermined amount payable.

The system also includes a processor disposed in communication with the memory, the processor being adapted to receive a request from a service provider for payment in respect of services provided to a member of the medical insurance scheme.

The processor is further adapted to determine if payments made to service providers on behalf of the member exceed the predetermined amount within a predetermined period and if so to request a payment from a credit facility of the member. If a payment from the credit facility of the member is approved then effecting payment to the service provider.

Where the credit facility is in the form of a credit card, for example, members of the medical scheme can be motivated to look after their health by awarding them discounts on purchases made using the credit card.

In this regard, South African patents numbers 99/1746 and 2001/3936, the contents of which are incorporated herein by reference, describe a method of managing a medical insurance plan wherein a plurality of health-related facilities and or services are offered to members of the medical insurance plan. The patents list a number of health-related facilities and/or services, examples of which are an approved health club or gymnasium, a weight-loss programme or a smoke ender programme. Use of the facilities and/or services by members is monitored and points are awarded to a member for using the facilities and/or services. The following table summarises examples of points-earning activities:

| | Detailed | | Points | |
|---|---|---|---|---|
| Category | category/activity | Eligibility | awarded | Frequency |
| Fitness | Gym workout | Any | 5 | per workout |
| | Fitness | Any | 75 | per assessment |
| | assessment | | | |
| | Organised | Any | 20 | per event |
| | fitness event | | | |
| Healthy | Being a non- | Any | 250 | per year |
| choices | smoker | | | declaration |
| | | | | made |
| | If a smoker, | Any | 150 | per event |
| | joining a | | | |
| | smoke-ender | | | |
| | program | | | |
| | Reading self | Any | 10 | per article |
| | help articles | | | |
| | Online risk | Any | 25 | per assessment |
| | assessment | | | |
| | Completing a | Any | 30 | points earned |
| | first aid | | | in each of |
| | course | | | the two years |
| | Passing an | Any | 40 | per event |
| | online health | | | |
| | information | | | |
| | quiz | | | |
| | Stress centre | Any | 25 | per assessment |
| Preventative | Regular | <12 | 250 | per event |
| measures | checkups | years | | |
| | for child, | | | |
| | baby | | | |
| | Completed | <24 | 200 | per event |
| | vaccinations | months | | |
| | Mammogram | women >45 | 250 | per event |
| | | years | | |
| | Glaucoma | >40 | 250 | points in each |
| | testing | years | | of the two |
| | | | | years |
| | Glucose | >40 | 250 | points in each |
| | testing | years | | of the two |
| | | | | years |
| | Dental | Any | 150 | per event |
| | checkups | | | |
| | Pap smears | women >16 | 250 | per event |
| | | years | | |
| | Cholesterol | men >35, | 250 | points in each |
| | screening | women >45 | | of the five |
| | | | | years |
| | Prostate | men >50 | 250 | per event |
| | screening | | | |
| | Use online/ | Any | 20 | per event |
| | telephone GP | | | |
| | Flu | Any | 150 | per event |
| | vaccination | | | |
| Nutrition | Online | Any | 10 | per article |
| | nutrition | | | |
| | articles | | | |
| | Creating | Any | 30 | per event |
| | healthy meal | | | |
| | plan online | | | |
| Results | Maintaining | Any | 30 | per level |
| | fitness | | | maintained |
| | rating | | | |
| | Improving | Any | 50 | per level |
| | fitness | | | improved |
| | rating | | | |
| | Maintaining | Any | 30 | per level |
| | target BMI | | | maintained |
| | band | | | |
| | Improving | Any | 50 | per level |
| | target BMI | | | improved |
| | band | | | |
| | Maintaining | Any | 30 | per level |
| | body fat | | | maintained |
| | target | | | |
| | Improving | Any | 50 | per level |
| | body fat | | | improved |
| | target | | | |
| | Maintaining | Any | 30 | per level |
| | blood | | | maintained |
| | pressure | | | |
| | Improving | Any | 50 | per level |
| | blood | | | improved |
| | pressure | | | |
| | No sick days | Any | 200 | per year |
| | off work | | | achieved |
| | bonus | | | |
| | Carryovers | | | |
| | Total points | | | |
| | end of | | | |
| | second year | | | |
| | . . . third | 10% | | |
| | . . . fourth | 15% | | |
| | . . . fifth+ | 20% | | |

Further, as described in these patents, a plurality of status levels in an incentive scheme are defined which are described in these patents as blue, bronze, silver and gold. Depending on the number of points a member is awarded, one of these status levels are allocated to the member so that the member's status level is essentially according to the use of the facilities and or services.

Finally, a reward is allocated to the members depending on their status level.

According to the present invention, the reward will be a predetermined discount when using the credit card to make purchases, wherein the discount it typically in the form of a percentage and the percentage increases as depending on the member's status level.

For example, a gold member may be awarded a 10% discount; a silver member a 7% discount, a bronze member a 5% discount and a blue member a 2% discount.

In one embodiment the discounts apply only when purchases are made at certain participating shops while in another embodiment the discount will apply irrespective of the shop.

Certain participating shops may give more or less discounts than other participating shops.

Thus it will be appreciated that the healthier a member is the more they will save on purchases made using the credit facility.

1. A method of effecting a payment to a service provider on behalf of a member of a medical scheme, the method including:
receiving a request from a service provider for payment in respect of services provided to a member of the medical insurance scheme;
determining if payments made to service providers on behalf of the member exceed a predetermined amount within a predetermined period;
if payments made exceed the predetermined amount, requesting a payment from a credit facility of the member; and
if a payment from the credit facility of the member is approved then effecting payment to the service provider.

2. A method according to claim 1 wherein payment is effected by transferring data to a financial institution, the data including at least data identifying the member, the service provider and an amount to be paid to the service provider.

3. A method according to claim 1 wherein the level of the member in an incentive scheme is used to calculate a discount which the member will receive when using the credit facility to effect purchases.

4. An electronic system for effecting a payment to a service provider on behalf of a member of a medical scheme, the system including:
a memory for storing:
information relating to payments made to service providers on behalf of a member in a predetermined period; and
information relating to a predetermined amount payable; and
a processor disposed in communication with the memory, the processor being adapted to:
receive a request from a service provider for payment in respect of services provided to a member of the medical insurance scheme;
determining if payments made to service providers on behalf of the member exceed the predetermined amount within a predetermined period;
if payments made exceed the predetermined amount, requesting a payment from a credit facility of the member; and
if a payment from the credit facility of the member is approved then effecting payment to the service provider.

5. An electronic system according to claim 4 wherein the processor is further adapted to effect payment by transferring data to a financial institution, the data including at least data identifying the member, the service provider and an amount to be paid to the service provider.

6. An electronic system according to claim 4 wherein the processor is further adapted to use the level of the member in an incentive scheme to calculate a discount which the member will receive when using the credit facility to effect purchases.
